(19) United States
(12) Patent Application Publication
(10) Pub. No.: US 2015/0310551 A1
(43) Pub. Date: Oct. 29, 2015

(54) Integrated Computing System for Developing a Commodity Status for Biomass

(71) Applicant: Verdante Bioenergy Services, LLC, Lenoir, NC (US)

(72) Inventor: George David Waechter, Lenoir, NC (US)

(21) Appl. No.: 14/695,741

(22) Filed: Apr. 24, 2015

Related U.S. Application Data
(60) Provisional application No. 61/983,873, filed on Apr. 24, 2014.

(51) Int. Cl. G06Q 40/04

(52) U.S. Cl. CPC G06Q 40/04

(57) ABSTRACT

The present invention is directed to a system for matching parties to a transaction of a biomass feedstock including at least one mobile sensory device structured and disposed for collecting biomass data for the biomass feedstock; a data storage repository configured to store seller criteria and a group of buyer criteria; and a processor of a central server configured to access the storage repository and execute software instructions stored in memory for receiving a group of buyer criteria, wherein each of the group of buyer criteria is sent from a buyer computing device used by one of a group of buyers of the biomass feedstock; receiving seller criteria for the biomass feedstock sent from a seller computing device or the at least one mobile sensory device; and sending the user criteria to the buyer and seller account messages to indicate potential market activity.

### BACKGROUND OF THE INVENTION

This application is based on and claims priority to provisional patent application No. 61/983,873 filed on Apr. 24, 2014.

### FIELD OF INVENTION

The present invention relates to biomass feedstocks and, more particularly, to a computing system for developing a commodity status for biomass feedstocks.

### DISCUSSION OF THE RELATED ART

Biomass refers to organic matter produced by plants and/or animals. Biomass includes trapped solar energy that can be converted to electricity, heat, or liquid fuels. Examples of biomass feedstocks include crop residues such as corn stover, sugarcane bagasse, purpose-grown grass crops, and woody materials such as chips and sawdust. Biomass feedstock is any biological material that meets specification for a technology to convert it into energy.

Biomass feedstocks are converted into energy by directly burning the feedstocks to produce steam for heat and power or by refining the feedstocks into liquid fuels and/or products. Energy generation from biomass has substantially lower environmental impacts than traditional fossil fuels. Furthermore, a general move toward environmentally-friendly energy incites many businesses to adopt “green” technologies and support environmentally friendly processes. However, because biomass feedstocks are typically bulky and costly to transport, a big challenge today is for geographically dispersed bio-refineries to obtain the required amount and quality biomass feedstock to operate the facility efficiently.

Biomass is not yet a commodity because it is highly variably, widely dispersed, and typically unquantified at a scale that translates to financial market protocols. Without means to rapidly quantify and qualify materials, it is difficult to establish meaning classifications for biomass that leads to commodity status.

### SUMMARY

in one embodiment of he present invention there is provided a system for matching parties to a transaction of a biomass feedstock including at least one mobile sensory device structured and disposed for collecting biomass data for the biomass feedstock; a data storage repository configured to store seller criteria and a group of buyer criteria; and a processor of a central server configured to access the storage repository and execute software instructions stored in memory for receiving a group of buyer criteria, wherein each of the group of buyer criteria is sent from a buyer computing device used by one of a group of buyers of the biomass feedstock, wherein the group of buyers comprises a buyer, and wherein each of the group of buyer criteria comprises a purchase quantity, a buyer price, and a transaction location at which to buy the biomass feedstock; receiving seller criteria for the biomass feedstock sent from a seller computing device or the at least one mobile sensory device, wherein the seller criteria comprises a sales volume of biomass from an area of production used to produce the biomass feedstock, proposed pricing, a location or group of locations at which to procure the biomass feedstock, and the biomass data as a representation of biomass specification data; matching, within a predetermined distance to a prospective buyer after receiving the group of buyer criteria, each of the group of buyers with the seller based on determining that the volume and representation of biomass specification data is sufficient to meet the purchase parameters and the transaction location at which to buy the biomass feedstock falls within the group of locations' pre-determined distance-to-market radii; and sending the user criteria to the buyer and seller account messages to indicate potential market activity.

In another embodiment of the present invention there is provided a method for providing an information technology platform for facilitating commercial transactions for biomass feedstocks and related goods and services, including collecting, by at least one processing unit, a producer profile for each of a group of producers; collecting, by the at least one processing unit over at least one network, biomass data for the biomass associated with each of the group of producers via one or more mobile sensory devices; determining, by the at least one processing unit, a representation of biomass specification data based at least in part on the biomass data; providing, by the at least one processing unit over the at least one network, to a group of buyers access to the representation of biomass qualities; and facilitating, by the at least one processing unit, a purchase of the biomass from one or more members of the group of producers by one or more members of the group of buyers.

One method provides an electronic forum for facilitating commercial transactions for biomass feedstocks and related goods and services includes collecting a producer profile for each of a group of producers, collecting biomass data for the biomass associated with each of the group of producers, determining a representation of biomass qualities using data accumulated via remote sensing technologies, providing to a group of buyers access to the representation of biomass specification data through the electronic forum, and facilitating purchase of the biomass from one or more of the group of producers by one or more of the group of buyers.

### BRIEF DESCRIPTION OF THE DRAWINGS

For a fuller understanding of the nature of the present invention, reference should be made to the following detailed description, taken in conjunction with the accompanying drawings in which:

FIG. 1 illustrates a computing device and its relevant components including an application with a producer profile that collects biomass feedstock location, contact, type, qualities, quantity and cost information;

FIG. 2 illustrates a computing device and its relevant components including an application with a buyer profile that collects biomass feedstock location, contact, type, qualities, quantity and cost information

FIG. 3 illustrates the electronic system for acilitating commercial transactions for biomass feedstocks between producers and buyers, and

FIG. 4 illustrates the transactional process of the integrated computing system for developing a commodity status for biomass of the present invention according to one embodiment and including a bid/ask platform.

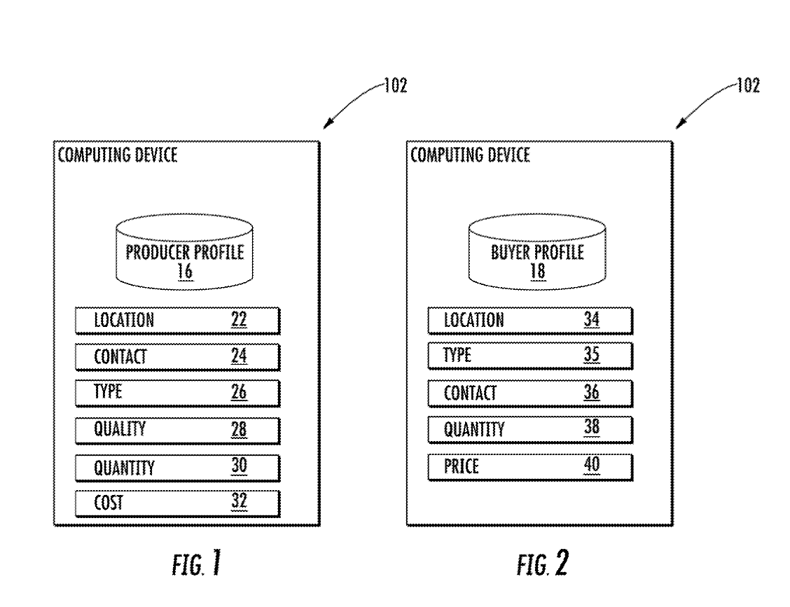

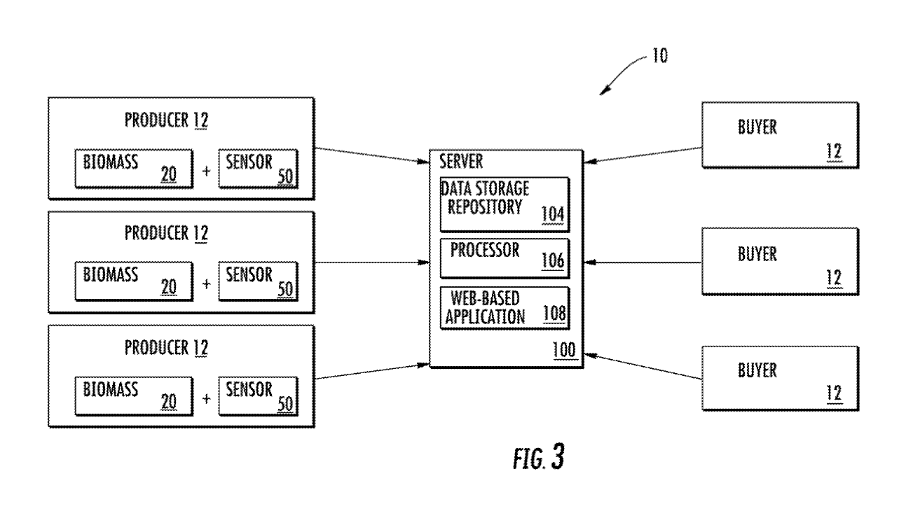

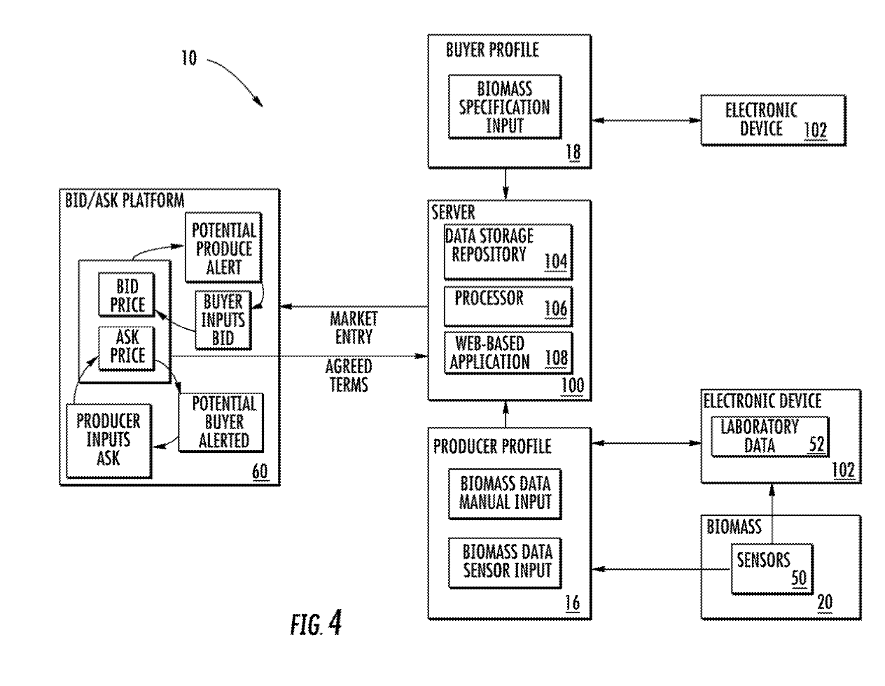

Like reference numerals refer to like parts throughout the everal views of the drawings.

### DETAILED DESCRIPTION OF THE PREFERRED EMBODIMENTS

Referring to the several views of the drawings, the biomass management and exchange system of the present invention is shown and described herein and is generally indicated as 10.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

It should also be noted that a plurality of hardware and software based devices, as well as a plurality of different structural components can be used to implement the invention. In addition, it should be understood that embodiments of the invention can include hardware, software, and electronic components or modules that, for purposes of discussion, can be illustrated and described as if the majority of the components were implemented solely in hardware. However, one of ordinary spilt in the art, and based on a reading of this detailed description, would recognize that, in at least one embodiment, the electronic based aspects of the invention can be implemented in software (e,g., stored on non-transitory computer-readable medium) executable by one or more processors. As such, it should be noted that a plurality of hardware and software based devices, as well as a plurality of different structural components can be utilized to implement the invention. Furthermore, and as described in subsequent paragraphs, the specific configurations illustrated in the drawings are intended to exemplify embodiments of the invention and that other alternative configurations are possible.

The biomass management and exchange system 10 facilitates the exchange of biomass by connecting biomass producers 12 with biomass buyers 14. The biomass management and exchange system 10 creates two types of profiles: a producer profile 16 and a buyer profile 18. To create a producer profile 16, the producer 12 specifies identifying information about the producer 12 and the biomass material 20. For example, the producer can specify the location 22 of the biomass material, provide an owner's name for a contact name) 24, specify the type 26 of biomass material, provide measures regarding the qualities 28 of the biomass (e.g., age), provide at least an estimated quantity 30 of the biomass material, provide a cost 32 associated with the biomass material, and specify types and quantity of computing devices 102 associated with the producer profile 16 (e.g., a mobile phone, a laptop computer, a tablet computer, etc.). Similarly, to create a buyer profile 18, the buyer 14 specifies information about the buyer and the desired biomass material. For example, the buyer can specify the location 34 of the business in need of a particular type 35 of biomass material, provide a contact name 36, provide an estimate of the quantity 38 of biomass desired, provide at least an estimate of the price 40 the buyer is willing to pay for the biomass material, and specify types and quantity of computing devices associated with the buyer profile 18.

The biomass management and exchange system 10 includes a data storage repository 104, processor 106 and one or more applications 10$, such as web-based applications, for operating and controlling related hardware and software, as part of a server 100 that stores a multitude of buyer profiles 18 and producer profiles 16, The biomass management and exchange system 10 can be accessed through a network (i.e., the Internet) through a computing device 102 (e.g., a smartphone). In some instances, the biomass management and exchange system 10 is partly hosted in the computing device while other parts of the biomass management and exchange system 10 are accessed through a network. The biomass management and exchange system 10 connects the biomass buyers 14 with the biomass producers 12 and allows the biomass buyers and producers to negotiate with each other to buy and sell biomass feedstock 20. Using the biomass management and exchange system 10, a buyer 14 can locate and communicate with different producers 12 and obtain the biomass material 20 in the most efficient and cost-effective method. Similarly. by using the biomass management and exchange system 10, biomass producers 12 can reach biomass buyers 14 who didn't know about the producers before. Thus, the biomass management and exchange system 10 increases the buying and selling options for both the biomass buyers and the biomass producers.

The biomass management and exchange system 10 also includes other information to encourage and facilitate transactions between the producers 12 and the buyers 14. For example, the biomass management and exchange system 10 can include market data including, for example, global market price data for biomass feedstock, typical or average availability, within a specified range, of different types of biomass feedstock and other relevant information for the market of biomass material. The b omass management and exchange system 10 can also include business intelligence information, For example, the biomass management and exchange system 10 can provide information to a business leader about progression toward attaining different business goals (for example, progress made in opening a new energy generating plant), or effective biomass producing methods, and the like. The biomass management and exchange system 10 can also collect information about the biomass producers 12 and the biomass buyers 14 such as, for example, how much biomass feedstock 20 a particular producer sells and how often, how much biomass feedstock a particular buyer buys in a given amount of time, what type of biomass feedstock a particular buyer buys, from how many different producers a particular buyer obtains the biomass feedstock 20, as well as other information of the sort. The collection of this type of information allows the biomass management and exchange system 10 to analyze the selling and buying habits of the biomass producers and the biomass sellers and provide each buyer/producer with different prediction algorithms. For example, the prediction algorithms can be related to where biomass may be needed and/or produced, an estimated price of biomass for a future period of time, and the like. This type of predictability can lead to biomass feedstock 20 becoming a commodity with increased standards and protocols being apparent via data analysis. The biomass management and exchange system 10 also includes an opportunity for relevant products and/or services to be advertised to biomass producers and buyers, for example, transportation and/or logistics companies to deliver biomass feedstock to the buyers.

The following is an illustrative example of the biomass management and exchange system 10 in use. A biomass producer 12 first produces and collects the biomass raw material 20. The producer then creates a producer profile 16 using the biomass management and exchange system 10 through a web-based application 108 on an computing device 102. The producer 12 specifies identifying information, such as the location of the biomass, the type of biomass, the age of the biomass, and, optionally, the computing devices 102 (e.g., smartphones, computers, tablet computers) used to access the producer profile. Using one or more sensors 50, (e.g., a wireless, Bluetooth® humidity sensor), the producer 12 measures at least one qualitative quality of the biomass, for example the humidity of the biomass feedstock. In one embodiment, the sensor 50 is connected to, or a part of, the computing device 102. Each sensor 50 is configured to automatically upload the qualitative information, such as the humidity reading, to the producer profile 16, where the information is associated with a particular biomass stack (Le,, at least a portion of the biomass feedstock produced). In some instances, a conventional humidity sensor 50 is used to measure the humidity of the biomass feedstock 20. In such instances, the humidity value may be manually updated to the producer profile 16 by the producer 12. The biomass management and exchange system 10 can differentiate between an automatic humidity reading from a humidity sensor 50 and a manual entry of a humidity reading. In other instances, other qualities of the biomass is measured (e,g., content of a particular chemical, the particle size of the biomass) using a sensor 50 and uploaded to the producer profile 16. The producer 12 can also upload pictures of the biomass 20 to the profile 16. Other non-limiting information associated with the biomass can include weather data, time, and location data associated with the biomass 20. In other instances, a near infrared sensor can be used and/or unmanned surveillance of the biomass can be performed by installing additional sensors 50. If the producer 12 sells more than one biomass stack, the producer can associate different pictures with different biomass stacks. Once all the information regarding the biomass 20 and the location 22 of the biomass is uploaded to the producer profile 16, the producer 12 can begin to search for potential buyers 14 and offer the producers' biomass 20 for sale at a particular price 32.

The producer 12 can also input laboratory data 52 for validation either via uploading reports or relevant documentation, photos, videos, and the like. The laboratory data 52 can also be contributory to the specification of the biomass material 20. The cumulative data obtained through the sensors 50 (e.g., the humidity sensor) and from laboratory data 52 is aggregated by the biomass management and exchange system 10, The biomass management and exchange system 10 analyzes the received data from the producers 12 and, using predictive algorithms, develops predictions of future biomass production, usage, and one or more qualities. For example, the biomass management and exchange system 10 gathers the biomass data from various producers and uses the biomass data to detect patterns and predict, in one such instance, a category that a biomass harvested in the future would fall into, the probability that a given biomass feedstock 20 on the biomass management and exchange system 10 will be within predetermined specifications, and/or the probability that a given biomass feedstock will become compliant with predetermined specifications over time. The pattern detection, data collection, and data processing and analysis can help to develop reliable commodity constraints for biomass, which can facilitate and encourage transactions of biomass materials.

A biomass buyer 14 creates a buyer profile 18 in a similar manner. As provided above, the buyer 14 specifies the location 34 of the business (typically an energy generating plant), the type 35 of biomass the buyer wants, and, optionally, the computing devices 102 used to access the buyer profile 18. The buyer 14 then searches for appropriate biomass producers 12. The buyer 14 can search for biomass producer profiles 16 and sort them according to different categories, for example, price of biomass unit, location, date available. Since transporting biomass feedstock may be costly, it is beneficial for the buyer to search for producers within a specified geographic range or perimeter. This way, transportation costs can be minimized. To this end, the biomass management and exchange system 10 allows the buyer 14 to restrict a search to a specified geographic area.

The buyer 14 then identifies the producers 12 from which to obtain the biomass 20. The buyer then initiates contact with the producer and offers to buy at least some biomass material. In some examples, rather than waiting for a buyer to approach a producer,, the producer can search for a buyer and initiate contact with the buyer.

After a buyer 14 and producer 12 have connected, a series of negotiations and/or between the producer 12 and the buyer 14 take place until an agreement is reached. The negotiations and/or bidding may take place on an electronic bid/ask platform 60 through the computer-based system over the server 100 or external to the computer-based system (e.g., phone conference). The agreement can include transportation parameters, delivery date, one or more qualities of the biomass, the price paid for the biomass 20, and the like. In some embodiments, the biomass management and exchange system 10 is configured to generate one or more agreement forms that indicate the parameters of the transaction. The details, discussed above, can include transportation parameters, a delivery date, qualities of the biomass, a price paid, and the like. In some embodiments, the biomass management and exchange system 10 stores different predetermined options for each parameter of the transaction. These stored options allow a buyer or a producer to quickly and easily choose a different option for a particular parameter. In some embodiments, the buyer 14 and/or the producer 14 can also specify a new parameter and customize it accordingly. The data from the transaction is loaded to the biomass management and exchange system to improve the algorithms and to increase the business intelligence of the system. In some instances, the biomass is monitored via the biomass management and exchange system until the biomass is delivered to the buyer. The biomass can be monitored for quality assurance purposes by measuring, for example. the humidity of the biomass. In some embodiments, the humidity of the biomass is measured when the biomass leaves an originating location. Based on the measured humidity, an expected humidity (or humidity range) at a destination can be calculated. The humidity of the biomass can then be measured at the destination to ensure that the humidity is within the expected range. The biomass can also be monitored via a GPS system'to calculate an estimated time of arrival. All of this information is made available to users through the computer-based system.

Each buyer can store information about the different producers in the biomass management and exchange system. For example, the buyer can store exact locations of the biomass for a particular producer, the fastest and/or most direct route to a producer location, costs associated with a particular producer, past transactions and results associated with a particular producer. The information associated with a particular producer can be visible to all or some of the users of the biomass management and exchange system. However, in some embodiments, the identity of the buyer who posted the information remains confidential. Thus, each producer can be rated in comparison with other producers and other buyers can make more informed decisions when negotiating with a particular producer. Each producer can also store information about the different buyers, such as, for example, exact locations associated with the buyers with most direct/fastest routes, past transactions with a particular buyer, and the like. The information associated with a particular buyer can be visible to all or some of the users of the biomass management and exchange system. However, in some embodiments, the identity of the producer who posted the information remains confidential. Thus, each buyer can be rated in comparison with other buyers and other producers can make more informed decisions when negotiating with a particular buyer. In some embodiments, only select users of the biomass management and exchange system have access to historical information associated with each buyer and/or each producer.

It should be understood that the above described methods and systems can be used with biomass and other bioenergy materials, including but not limited to biodiesel, ethanol, bio-chemicals, wood, woody materials, plant material, corn stover, straws and the like.

Therefore, the biomass management and exchange system 10 connects biomass producers 12 and biomass buyers 14 such that costs are minimized and the quality of the biomass feedstock is maintained. The biomass management and exchange system 10 also offers other tools for the producers and buyers to access information associated with the biomass market (local and global) and to run their own business.

While the present invention has been shown and described in accordance with several preferred and practical embodiments, it is recognized that departures from the instant disclosure are contemplated within the spirit and scope of the present invention which are not limited except as defined in the following claims as interpreted by the Doctrine of Equivalents.

What is claimed is:

1. A system for matching parties to a transaction of a biomass feedstock comprising:
at least one mobile sensory device structured and disposed for collecting biomass data for the biomass feedstock;
a data storage repository configured to store seller criteria and a group of buyer criteria; and
a processor of a central server configured to access the data storage repository and execute software instructions stored in memory for:
receiving a group of buyer criteria, wherein each of the group of buyer criteria is sent from a buyer computing device used by one of a group of buyers of the biomass feedstock, wherein the group of buyers comprises a buyer, and wherein each of the group of buyer criteria comprises a purchase quantity, a buyer price, and a transaction location at which to buy the biomass feedstock;
receiving seller criteria for the biomass feedstock sent from a seller computing device or the at least one mobile sensory device, wherein the seller criteria comprises a sales volume of biomass from an area of production used to produce the biomass feedstock, proposed pricing, a location or group of locations at which to procure the biomass feedstock, and the biomass data as a representation of biomass specification data;
matching, within a predetermined distance to a prospective buyer after receiving the group of buyer criteria, each of the group of buyers with the seller based on determining that the volume and representation of biomass specification data is sufficient to meet the purchase parameters and the transaction location at which to buy the biomass feedstock falls within the group of locations' pre-determined distance-to-market radii; and
sending the group of buyer and seller criteria to the seller and buyer, respectively, to indicate potential market activity.

2. The system as recited in claim 1, wherein the biomass data includes at least one of temperature data and moisture data.

3. The system as recited in claim 1, wherein the biomass data includes chemical composition information for the biomass.

4. A method for providing an information technology platform for facilitating commercial transactions for biomass feedstocks and related goods and services, comprising:
collecting, by at least one processing unit, a producer profile for each of a group of producers;
collecting, by the at least one processing unit over at least one network, biomass data for the biomass associated with each of the group of producers via at least one mobile sensory device;
determining, by the at least one processing unit, a representation of biomass specification data based at least in part on the biomass data;
providing, by the at least one processing unit over the at least one network, to a group of buyers access to the representation of biomass specification data; and
facilitating, by the at least one processing unit, a purchase of the biomass from one or more members of the group of producers by one or more members, of the group of buyers.

5. The method of claim 4, wherein the biomass data includes at least one of temperature data and moisture data.

6. The method of claim 4, further comprising collecting geo-spatial location information for the biomass.

7. The method of claim 4, wherein the biomass data includes visual information including at least one selected from the group comprising a photograph and a video.

8. The method of claim 4, wherein facilitating a purchase of the biomass from one or more of the group of producers by one or more of the group of buyers includes receiving from one of the producers a selection of one or more of the group of buyers, a number of units for sale, a specific asking price, a delivery point, and a delivery period.

9. The method of claim 8, wherein the step of facilitating a purchase of the biomass from one or more of the group of producers by one or more of the group of buyers further includes receiving from one of the buyers an acceptance or a counteroffer.

10. A method for matching parties to a transaction of a biomass feedstock, the method comprising:
receiving a group of buyer criteria, wherein each of the group of buyer criteria is sent from a buyer computing device used by one of a group of buyers of the biomass feedstock, wherein each of the group of buyer criteria comprises at least one of a purchase volume, buyer specification, a buyer price, and a delivery location at which the biomass feedstock shall be received;
receiving seller criteria for the biomass feedstock sent from a seller computing device and at least one mobile sensory device structured and disposed for collecting biomass data for the biomass feedstock, wherein the seller criteria comprises a sales volume of biomass from an area of production used to produce the biomass feedstock, proposed pricing, a location or group of locations at which to procure the biomass feedstock, and the biomass data as a representation of biomass specification data;
matching, within a predetermined distance to a prospective buyer after receiving the group of buyer criteria, each of the group of buyers with the seller based on determining that the volume and representation of biomass specification data is sufficient to meet the purchase parameters and the transaction location at which to buy the biomass feedstock falls within the group of locations' pre-determined distance-to-market radii; and
sending the group of buyer and seller criteria to the seller and buyer, respectively to indicate potential market activity.

11. The method of claim 10, wherein when the buyer is unwilling to execute the transaction of the biomass feedstock with the seller at a transaction price based on biomass specifications and other criteria, the buyer submits a counteroffer to a member of or the entire group of prospective sellers.

12. method of claim 10, wherein when the seller is unwilling to execute the transaction of the biomass feedstock with the buyer at a transaction price based on biomass specifications and other criteria, the seller submits a counteroffer to a member of or the entire group of prospective buyers.

13. method of claim 10, further comprising storing the transaction price and generating a history of transaction prices for the biomass feedstock, the history of transaction prices comprising the transaction price and a group of previously executed transaction prices.

14. The method of claim 13, wherein the history of transaction prices for the biomass feedstock is based on transaction location, biomass specification data, weather, reliability, transportation distance, insurability, sustainability certification, or other parameters deemed significant to the transaction process.

15. method of claim 10, wherein the seller criteria further includes a production location where the biomass feedstock has been or will be produced.

16. The method of claim 15, further comprising:
receiving weather data for the production location;
generating weather information using the weather data for the production location; and
sending the weather information to the buyer and seller computing devices, wherein the weather information is used to assist the buyer and seller in transacting or otherwise managing the biomass feedstock inventory.

17. The method of claim 10, further comprising:
receiving, from the primary buyer computing device, revised buyer criteria from the group of buyer criteria, wherein the revised buyer criteria comprises at least one selected from a group consisting of a revised buyer price and a revised purchase quantity; and
upon receiving the revised buyer criteria, sending the revised buyer criteria to the seller computing device.

18. The method of claim 10, further comprising:
receiving reliability data corresponding to production of the biomass feedstock and generating reliability information therefrom, and
sending the reliability information corresponding to the production of the biomass feedstock to the buyer computing device.

19. method of claim 18, wherein the reliability information comprises at least one datum selected from a group consisting of information about a deficiency effecting the biomass feedstock, instructions for repairing the deficiency, instructions for increasing production of the biomass feedstock, and a suggestion to augment the biomass feedstock production specifications based on the seller criteria and the reliability information.

20. The method of claim 10, wherein each of the group of buyer criteria further comprises a total quantity category defined by a range of purchase quantities, and wherein the group of seller criteria further comprises a production category defined by a range of productions, wherein matching each or an aggregate of the group of buyers with a seller or an aggregate of sellers is further based on the quantity category falling within the distance-to-market and biomass feedstock specification parameters.
